(19) United States
(12) Patent Application Publication
(10) Pub. No.: US 2022/0064056 A1
(43) Pub. Date: Mar. 3, 2022

(54) LOW-WARP, STRENGTHENED ARTICLES AND CHEMICAL SURFACE TREATMENT METHODS OF MAKING THE SAME

(71) Applicant: CORNING INCORPORATED, CORNING, NY (US)

(72) Inventors: Jun Hou, Painted Post, NY (US); Tao Tao, Songjiang, Shanghai (CN); Jianqiang Zhu, Shanghai, Jiading District (CN)

(21) Appl. No.: 17/415,322

(22) PCT Filed: Dec. 6, 2019
(86) PCT No.: PCT/US2019/064859

§ 371 Date: Jun. 17, 2021

(30) Foreign Application Priority Data
Dec. 20, 2018 (CN) 201811562889.7

(51) Int. Cl. C03C 15/00; C03C 21/00

(52) U.S. Cl. CPC C03C 15/00; C03C 21/002

(57) ABSTRACT

A method of making strengthened glass articles that includes: providing an article comprising ion-exchangeable alkali metal ions and first and second primary surfaces; etching the first primary surface with an etchant having a pH of less than 7 to form an etched first primary surface; forming an anti-glare surface integral with the second primary surface after masking the first primary surface with a masking film; removing the masking film; providing a first ion-exchange bath comprising ion-exchanging alkali metal ions, each having a larger size than the size of the ion-exchangeable alkali metal ions; and submersing the article in the first bath to form a strengthened article. Further, the strengthened article comprises a compressive stress region extending from the etched first primary surface and the second primary surface to first and second selected depths, respectively. The etching step can be conducted in an etchant-containing bath or with a sponge-rolling apparatus.

### CROSS-REFERENCE TO RELATED APPLICATIONS

This application claims the benefit of priority under 35 U.S.C. § 119 of Chinese Patent Application Serial No. 201811562889.7 filed on Dec. 20, 2018 the content of which is relied upon and incorporated herein by reference in its entirety.

### FIELD OF THE DISCLOSURE

The present disclosure relates generally to low-warp, strengthened articles and methods of making these articles; and, more particularly, asymmetric ion-exchange methods of making strengthened glass, glass-ceramic and ceramic substrates employed in various optical articles.

### BACKGROUND

Protective display covers based on chemically strengthened, ion-exchanged glass substrates are employed in several industries, including consumer electronics (e.g., smartphones, slates, tablets, notebooks, e-readers, etc.), automotive, interior architecture, defense, medical and packaging. Many of these display covers employ Corning® Gorilla Glass® products, which offer superior mechanical properties including damage resistance, scratch resistance and drop performance. As a manufacturing method, chemical strengthening by ion exchange of alkali metal ions in glass, glass-ceramic and ceramic substrates has been employed for many years in the industry to provide these superior mechanical properties. Depending upon the application, a stress profile of compressive stress as a function of depth can be targeted by these ion-exchange methods to provide the targeted mechanical properties.

In a conventional ion-exchange strengthening process, a glass, glass-ceramic or ceramic substrate is brought into contact with a molten chemical salt so that alkali metal ions of a relatively small ionic diameter in the substrate are ion-exchanged with alkali metal ions of a relatively large ionic diameter in the chemical salt. As the relatively larger alkali metal ions are incorporated into the substrate, compressive stress is developed in proximity to the incorporated ions within the substrate, which provides a strengthening effect. As the typical failure mode of the substrates is associated with tensile stresses, the added compressive stress produced by the incorporation of the larger alkali metal ions serves to offset the applied tensile stress, leading to the strengthening effect.

One of the technical challenges associated with these ion-exchange strengthening processes is warpage of the strengthened substrates. In particular, warpage of the substrate can occur during or after the ion-exchange process when the ion-exchange process occurs in an asymmetric fashion between the two primary surfaces of the substrate. Asymmetries of the target substrates with regard to substrate geometries, substrate surfaces, coatings and films on the substrates, diffusivity of alkali metal ions, alkali metal ions in the salt bath and other factors may affect the extent and degree of the observed warpage of the target substrates.

Various approaches to managing warpage are employed in the industry. In general, these approaches tend to add significant cost to the production of glass, glass-ceramic and ceramic substrates employed in display applications and/or result in reduced, or less control over, optical properties. Warpage can cause difficulty in downstream processes associated with producing a display. For example, processes employed to make touch sensor display laminates can be prone to the formation of air bubbles in the laminates owing to the degree of warpage in the substrate. In some instances, additional thermal treatments and/or additional molten salt exposures can be employed to the substrates to counteract warpage associated with ion-exchange strengthening processes. However, these additional process steps result in significantly increased manufacturing costs and/or affect optical properties associated with the substrates. Other approaches, such as post-production grinding and polishing, can also counteract warpage effects, but again at significantly increased production costs.

Accordingly, there is a need for low-warp, strengthened glass, glass-ceramic and ceramic articles and ion-exchange methods for the same, including methods that offer the requisite degree of strengthening, limited cost increases and no effect on the optical properties associated with the articles.

### SUMMARY OF THE DISCLOSURE

According to an aspect of the present disclosure, a method of making a strengthened article includes: providing an article comprising a glass, glass-ceramic or ceramic composition with a plurality of ion-exchangeable alkali metal ions, a first primary surface and a second primary surface; etching the first primary surface with an etchant having a pH of less than 7 to form an etched first primary surface; forming an anti-glare surface integral with the second primary surface, the forming step conducted after masking the first primary surface with a masking film; removing the masking film from the first primary surface; providing a first ion-exchange bath comprising a plurality of ion-exchanging alkali metal ions, each having a larger size than the size of the ion-exchangeable alkali metal ions; and submersing the article in the first ion-exchange bath at a first ion-exchange temperature and duration to form a strengthened article. Further, the strengthened article comprises a compressive stress region extending from the etched first primary surface and the second primary surface to first and second selected depths, respectively. In some embodiments of this aspect, the etching step is conducted with a sponge-rolling apparatus configured to etch the first primary surface by direct contact with the first primary surface of the substrate.

According to some aspects of the present disclosure, a method of making a strengthened article includes: providing an article comprising a glass, glass-ceramic or ceramic composition with a plurality of ion-exchangeable alkali metal ions, a first primary surface and a second primary surface; masking the first primary surface with a first masking film; forming an anti-glare surface integral with the second primary surface after the step of masking the first primary surface; removing the first masking film on the first primary surface after the step of forming an anti-glare surface; masking the anti-glare surface with a second masking film; etching the first primary surface with an etchant having a pH of less than 7 to form an etched first primary surface after the step of masking an anti-glare surface; removing the second masking film on the anti-glare surface after the step of etching the first primary surface; providing a first ion-exchange bath comprising a plurality of ion-exchanging alkali metal ions, each having a larger size than the size of the ion-exchangeable alkali metal ions; and submersing the article in the first ion-exchange bath at a first ion-exchange temperature and duration to form a strengthened article, the submersing conducted after the step of removing the second masking film. Further, the strengthened article comprises a compressive stress region extending from the etched first primary surface and the second primary surface to first and second selected depths, respectively.

According to some aspects of the present disclosure, a method of making a strengthened article includes: providing an article comprising a glass, glass-ceramic or ceramic composition with a plurality of ion-exchangeable alkali metal ions, a first primary surface and a second primary surface; masking the second primary surface with a second masking film; etching the first primary surface with an etchant having a pH of less than 7 to form an etched first primary surface after the step of masking the second primary surface; removing the second masking film on the second primary surface after the step of etching the first primary surface; masking the first primary surface with a first masking film; forming an anti-glare surface on or within the second primary surface after the step of masking the first primary surface; removing the first masking film on the first primary surface after the step of forming an anti-glare surface; providing a first ion-exchange bath comprising a plurality of ion-exchanging alkali metal ions, each having a larger size than the size of the ion-exchangeable alkali metal ions; and submersing the article in the first ion-exchange bath at a first ion-exchange temperature and duration to form a strengthened article, the submersing conducted after the step of removing the second masking film. Further, the strengthened article comprises a compressive stress region extending from the etched first primary surface and the second primary surface to first and second selected depths, respectively.

According to some aspects of the disclosure, a strengthened glass article is provided that includes: a glass substrate comprising a first primary surface and a second primary surface, and a compressive stress region extending from the first and second primary surfaces to respective first and second selected depths. The second primary surface of the substrate comprises an integrally-formed anti-glare surface. In addition, the glass article comprises a change in warp (Δ warp) of 200 microns or less. The first primary surface comprises an etched first primary surface. Further, the change in warp is measured before and after formation of the compressive stress region, anti-glare surface and etched first primary surface in the glass substrate.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description describe various embodiments and are intended to provide an overview or framework to understanding the nature and character of the claimed subject matter.

The accompanying drawings are included to provide a further understanding of the various embodiments, and are incorporated into and constitute a part of this specification. The drawings illustrate the various embodiments described herein, and together with the description serve to explain the principles and operation of the claimed subject matter.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a cross-sectional, schematic view of a strengthened glass article comprising an anti-glare surface, according to an embodiment;

FIG. 2 is a method of making a strengthened article comprising an anti-glare surface, according to an embodiment;

FIG. 3 is a method of making a strengthened article comprising an anti-glare surface, according to an embodiment;

FIG. 4 is a method of making a strengthened article comprising an anti-glare surface, according to an embodiment; and

FIG. 5 is a schematic of a sponge-rolling apparatus that can be employed in conducting embodiments of the methods depicted in FIGS. 2-4, according to an embodiment of the disclosure.

The foregoing summary, as well as the following detailed description of certain inventive techniques, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, “compressive stress” (CS) and “depth of compressive stress layer” (DOL) are measured using means known in the art. For example, CS and DOL are measured by a surface stress meter using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to a modified version of Procedure C described in ASTM standard C770-98 (2013), entitled “Standard Test Method for Measurement of Glass Stress-Optical Coefficient,” the contents of which are incorporated herein by reference in their entirety. The modification includes using a glass disc as the specimen with a thickness of 5 to 10 mm and a diameter of 12.7 mm. Further, the glass disc is isotropic, homogeneous and core-drilled with both faces polished and parallel. The modification also includes calculating the maximum force, Fₘₐₓ, to be applied. The maximum force (Fₘₐₓ) is the force sufficient to produce 20 MPa compressive stress. The maximum force to be applied, Fmax, is calculated as follows according to Equation (1):

Fₘₐₓ=7.854*D*h (1)

where Fₘₐₓ is the maximum force in Newtons, D is the diameter of the glass disc, and h is the thickness of the light path. For each force applied, the stress is computed according to Equation (2):

$$σ = \frac{8 * {F}_{max}}{π * D * h} \qquad ( 2 )$$

where Fₘₐₓ is the maximum force in Newtons obtained from Equation (1), D is the diameter of the glass disc in mm, h is the thickness of the light path in mm, and σ is the stress in MPa.

As used herein, the “depth of compressive stress layer (DOL)” refers to a depth location within the strengthened article where the compressive stress generated from the strengthening process reaches zero.

As also used herein, “anti-glare”, “AG”, or like terms refer to a physical transformation of light contacting the treated surface of an article, such as a display, of the disclosure that changes, or to the property of changing light reflected from the surface of an article, into a diffuse reflection rather than a specular reflection. In embodiments, the AG surface treatment can be produced by chemical etching Anti-glare does not reduce the amount of light reflected from the surface, but only changes the characteristics of the reflected light. An image reflected by an anti-glare surface has no sharp boundaries. In contrast to an anti-glare surface, an anti-reflective surface is typically a thin-film coating that reduces the reflection of light from a surface via the use of refractive-index variation and, in some instances, destructive interference techniques.

As further used herein, the terms “haze”, “transmission haze” or like terms refer to a particular surface light scatter characteristic related to surface roughness. More particularly, these “haze” terms refer to the percentage of transmitted light scattered outside an angular cone of ±4.0° according to ASTM D1003. For an optically smooth surface, transmission haze is generally close to zero. Transmission haze of a glass sheet roughened on two sides (Haze_{2-side}) can be related to the transmission haze of a glass sheet having an equivalent surface that is roughened on only one side (Haze_{1-side}), according to the approximation of equation (3):

Haze_{2-side}≈[(1−Haze_{1-side})·Haze_{1-side}]+Haze_{1-side} (3)

Further, haze values are usually reported in terms of percent haze. The value of Haze_{2-side} from eq. (3) must be multiplied by 100.

As also used herein, the terms “gloss”, “gloss level,” or like terms refer to, for example, surface luster, brightness, or shine, and more particularly to the measurement of specular reflectance calibrated to a standard (such as, for example, a certified black glass standard) in accordance with ASTM procedure D523. Common gloss measurements are typically performed at incident light angles of 20°, 60°, and 85°, with the most commonly used gloss measurement being performed at 60°. Due to the wide acceptance angle of this measurement, however, common gloss often cannot distinguish between surfaces having high and low distinctness-of-reflected-image (DOI) values.

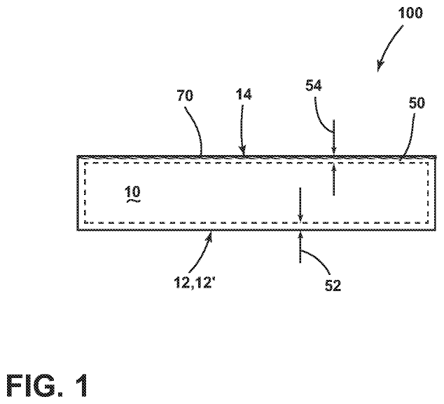

Referring to the drawings in general and to FIG. 1 in particular, it will be understood that the illustrations are for the purpose of describing particular embodiments and are not intended to limit the disclosure appended claims thereto. The drawings are not necessarily to scale, and certain features and certain views of the drawings may be shown exaggerated in scale or in schematic form in the interest of clarity and conciseness.

Described in this disclosure are strengthened articles, and methods of making them, that include substrates having a glass, glass-ceramic or ceramic composition and compressive stress regions. Further, these strengthened articles are optimized to exhibit little to no warpage as a result of the methods of the disclosure, despite having an anti-glare surface on one primary surface that would otherwise make them prone to warpage from asymmetric and/or non-uniform ion-exchange effects. In general, the methods of the disclosure control the kinetics of the ion-exchange process to offset any asymmetric or non-uniform ion-exchange conditions that are present in the substrates from the presence of the anti-glare surface or other comparable optical structure. The methods effect this control through adjustment of the surface morphology of the primary surface of the substrate opposite to the primary surface that comprise the anti-glare surface. This adjustment to the surface morphology of the primary surface opposite to the anti-glare surface can be effected through etching or another comparable process that increases the uptake of ion-exchanging ions during the strengthening process to offset the increase in the uptake of the same ion-exchanging ions associated with the presence of the anti-glare surface.

The methods of making strengthened articles of the disclosure, along with the strengthened articles themselves, possess several benefits and advantages over conventional approaches to manufacturing strengthened articles comprising glass, glass-ceramic and ceramic compositions. One advantage is that the methods of the disclosure are capable of reducing the degree of warp that would otherwise be induced by non-uniform ion-exchange conditions present in the substrates associated with the presence of an anti-glare surface. Another advantage is that the methods of the disclosure reduce or eliminate warpage without the need for additional processing steps, e.g., polishing, cutting, grinding, thermal treatments after ion exchange processing, etc. A further advantage of these methods is that they offer little to no increased capital and/or reductions in throughput relative to conventional ion-exchange processing. In particular, the additional fixtures associated with implementing the methods of the disclosure are limited in terms of size and cost (e.g., fixtures and baths for etching and masking surfaces of the substrates, etc.). Another advantage of these methods is that they result in compressive stress regions with the same or substantially similar residual stress profiles as compared to conventional ion exchange profiles, while offering the advantage of significantly reduced warpage levels in the strengthened articles produced according to the process. A further advantage of these methods is that they allow for the development of an anti-glare surface in the substrate prior to the development of a compressive stress region through an ion-exchange strengthening process, thus ensuring that the development of the anti-glare surface does not inhibit or reduce the magnitude of the compressive stresses during the strengthening process. Put another way, the development of an anti-glare surface, such as outlined in the disclosure, can, according to embodiments, reduce the thickness of the substrate by an order of magnitude that can reduce or eliminate the compressive stress region in a substrate that has been subjected to an ion-exchange strengthening process prior to development of the anti-glare surface.

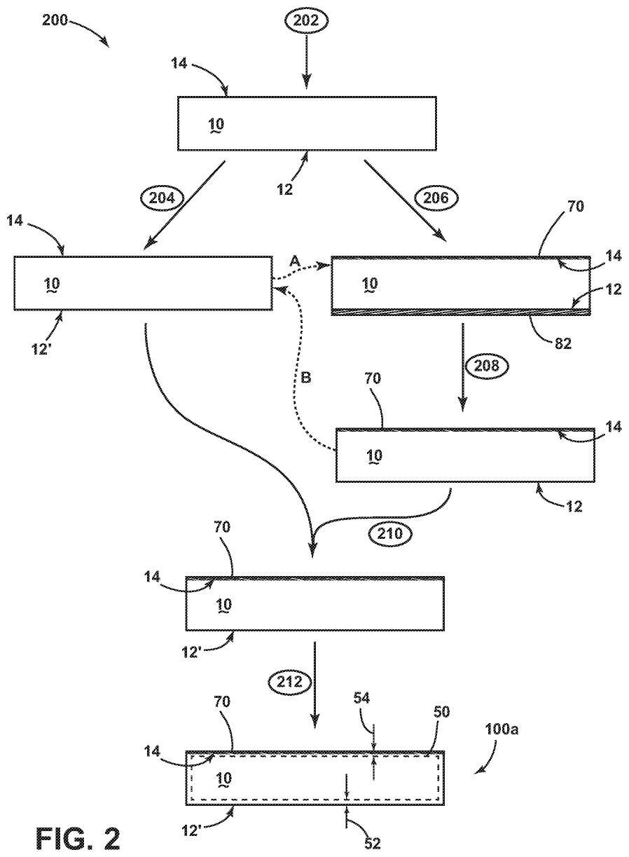

Referring to FIG. 1, a strengthened article 100 is depicted according to an embodiment of the disclosure. The strengthened glass article 100 includes: a glass substrate 10 that comprises a first primary surface 12 and a second primary surface 14, and a compressive stress region 50 extending from the first primary surface 12 and second primary surface 14 to respective first and second selected depths 52 and 54, respectively. The second primary surface 14 of the substrate comprises an integrally-formed anti-glare surface 70. In addition, the glass article 100 comprises a change in warp (Δ warp) of 200 microns or less. The first primary surface 12 comprises an etched first primary surface 12′. Further, the change in warp is measured before and after formation of the compressive stress region 50, anti-glare surface 70 and etched first primary surface 12′ in the glass substrate 10. The strengthened glass article 100 can be produced from the methods of making strengthened articles 200-400 outlined below in the disclosure, or other methods consistent with the methods 200-400 (see FIGS. 2-4 and corresponding description).

Referring again to FIG. 1, the strengthened glass article 100 possesses a compressive stress region 50 that extends to first and second selected depths 52, 54 from the respective first and second primary surfaces 12, 14. Further, the strengthened glass article 100 exhibits little to no warp. According to some embodiments, the strengthened glass article 100 is characterized by a change in warp (Δ warp) of about 200 microns or less, as measured before and after the formation of the compressive stress region 50, anti-glare surface 70 and etched first primary surface 12′. In some implementations, the change in warp (Δ warp) of the article 100 is about 300 microns or less, about 250 microns or less, about 200 microns or less, about 175 microns or less, about 150 microns or less, about 125 microns or less, about 100 microns or less, about 90 microns or less, about 80 microns or less, about 70 microns or less, about 60 microns or less, about 50 microns or less, about 40 microns or less, about 30 microns or less, about 20 microns or less, about 10 microns or less, and all change in warp (Δ warp) levels between these levels—i.e., as measured before and after the formation of the compressive stress region 50, anti-glare surface 70 and etched first primary surface 12′. Similarly, the strengthened glass articles 100 can exhibit a maximum warpage of less than 0.5% of the longest dimension of the article 100, less than 0.1% of the longest dimension of the article 100, or even less than 0.01% of the longest dimension of the article 100.

The substrates 10 employed in the strengthened glass articles 100 can comprise various glass compositions, glass-ceramic compositions and ceramic compositions. The choice of glass is not limited to a particular glass composition. For example, the composition chosen can be any of a wide range of silicate, borosilicate, aluminosilicate, or boroaluminosilicate glass compositions, which optionally can comprise one or more alkali and/or alkaline earth modifiers.

By way of illustration, one family of compositions that may be employed in the substrates 10 includes those having at least one of aluminum oxide or boron oxide and at least one of an alkali metal oxide or an alkaline earth metal oxide, wherein −15 mol %≤(R₂O+R′O—Al₂O₃—ZrO₂)—B₂O₃≤4 mol %, where R can be Li, Na, K, Rb, and/or Cs, and R′ can be Mg, Ca, Sr, and/or Ba. One subset of this family of compositions includes from about 62 mol % to about 70 mol % SiO₂; from 0 mol % to about 18 mol % Al₂O₃; from 0 mol % to about 10 mol % B₂O₃; from 0 mol % to about 15 mol % Li₂O; from 0 mol % to about 20 mol % Na₂O; from 0 mol % to about 18 mol % K₂O; from 0 mol % to about 17 mol % MgO; from 0 mol % to about 18 mol % CaO; and from 0 mol % to about 5 mol % ZrO₂. Such glasses are described more fully in U.S. Pat. Nos. 8,969,226 and 8,652,978, hereby incorporated by reference in their entirety as if fully set forth below.

Another illustrative family of compositions that may be employed in the substrates 10 includes those having at least 50 mol % SiO₂ and at least one modifier selected from the group consisting of alkali metal oxides and alkaline earth metal oxides, wherein [(Al₂O₃ (mol %)+B₂O₃(mol %))/(Σ alkali metal modifiers (mol %))]>1. One subset of this family includes from 50 mol % to about 72 mol % SiO₂; from about 9 mol % to about 17 mol % Al₂O₃; from about 2 mol % to about 12 mol % B₂O₃; from about 8 mol % to about 16 mol % Na₂O; and from 0 mol % to about 4 mol % K₂O. Such glasses are described more fully in U.S. Pat. No. 8,586,492, hereby incorporated by reference in its entirety as if fully set forth below.

Yet another illustrative family of compositions that may be employed in the substrates 10 includes those having SiO₂, Al₂O₃, P₂O₅, and at least one alkali metal oxide (R₂O), wherein 0.75≤[(P₂O₅(mol %)+R₂O(mol %))/M₂O₃ (mol %)]≤1.2, where M₂O₃=Aₗ₂O₃+B₂O₃. One subset of this family of compositions includes from about 40 mol % to about 70 mol % SiO₂; from 0 mol % to about 28 mol % B₂O₃; from 0 mol % to about 28 mol % Al₂O₃; from about 1 mol % to about 14 mol % P₂O₅; and from about 12 mol % to about 16 mol % R₂O. Another subset of this family of compositions includes from about 40 to about 64 mol % SiO₂; from 0 mol % to about 8 mol % B₂O₃; from about 16 mol % to about 28 mol % Al₂O₃; from about 2 mol % to about 12 mol % P₂O₅; and from about 12 mol % to about 16 mol % R₂O. Such glasses are described more fully in U.S. patent application Ser. No. 13/305,271, hereby incorporated by reference in its entirety as if fully set forth below.

Yet another illustrative family of compositions that can be employed in the substrates 10 includes those having at least about 4 mol % P₂O₅, wherein (M₂O₃(mol %)/RₓO(mol %))<1, wherein M₂O3=Al₂O₃+B₂O₃, and wherein RₓO is the sum of monovalent and divalent cation oxides present in the glass. The monovalent and divalent cation oxides can be selected from the group consisting of Li₂O, Na₂O, K₂O, Rb₂O, Cs₂O, MgO, CaO, SrO, BaO, and ZnO. One subset of this family of compositions includes glasses having 0 mol % B₂O₃. Such glasses are more fully described in U.S. patent application Ser. No. 13/678,013 and U.S. Pat. No. 8,765,262, the contents of which are hereby incorporated by reference in their entirety as if fully set forth below.

Still another illustrative family of compositions that can be employed in the substrates 10 includes those having Al₂O₃, B₂O₃, alkali metal oxides, and contains boron cations having three-fold coordination. When ion exchanged, these glasses can have a Vickers crack initiation threshold of at least about 30 kilograms force (kgf). One subset of this family of compositions includes at least about 50 mol % SiO₂; at least about 10 mol % R₂O, wherein R2O comprises Na₂O; Al₂O₃, wherein −0.5 mol %≤Al₂O₃(mol %)-R₂O(mol %)≤2 mol %; and B₂O₃, and wherein B₂O₃(mol %)-(R₂O(mol %)-Al₂O₃(mol %))≥4.5 mol %. Another subset of this family of compositions includes at least about 50 mol % SiO₂, from about 9 mol % to about 22 mol % Al₂O₃; from about 4.5 mol % to about 10 mol % B₂O₃; from about 10 mol % to about 20 mol % Na₂O; from 0 mol % to about 5 mol % K₂O; at least about 0.1 mol % MgO and/or ZnO, wherein 0≤MgO+ZnO≤6 mol %; and, optionally, at least one of CaO, BaO, and SrO, wherein 0 mol %≤CaO+SrO+BaO≤2 mol %. Such glasses are more fully described in U.S. patent application Ser. No. 13/903,398, the content of which is incorporated herein by reference in its entirety as if fully set forth below.

Unless otherwise noted, the strengthened glass articles (e.g., articles 100) and associated methods (e.g., methods 200-400 depicted in FIGS. 2-4 and their corresponding description) for producing them outlined in this disclosure are exemplified by being fabricated from substrates 10 having an alumino-silicate glass composition of 68.96 mol % SiO₂, 0 mol % B₂O₃, 10.28 mol % Al₂O₃, 15.21 mol % Na₂O, 0.012 mol % K₂O, 5.37 mol % MgO, 0.0007 mol % Fe₂O₃, 0.006 mol % ZrO₂, and 0.17 mol % SnO₂. A typical aluminosilicate glass is described in U.S. patent application Ser. No. 13/533,298, and hereby incorporated by reference.

Similarly, with respect to ceramics, the material chosen for the substrates 10 employed in the strengthened glass articles 100 can be any of a wide range of inorganic crystalline oxides, nitrides, carbides, oxynitrides, carbonitrides, and/or the like. Illustrative ceramics include those materials having an alumina, aluminum titanate, mullite, cordierite, zircon, spinel, perovskite, zirconia, ceria, silicon carbide, silicon nitride, silicon aluminum oxynitride, or zeolite phase.

Similarly, with respect to glass-ceramics, the material chosen for the substrates 10 can be any of a wide range of materials having both a glassy phase and a ceramic phase. Illustrative glass-ceramics include those materials where the glass phase is formed from a silicate, borosilicate, aluminosilicate, or boroaluminosilicate, and the ceramic phase is formed from β-spodumene, β-quartz, nepheline, kalsilite, or carnegieite.

The strengthened glass articles 100, including those that result from the methods of making strengthened articles 200-400 (see FIGS. 2-4 and corresponding description below), can adopt a variety of physical forms, including a glass substrate. That is, from a cross-sectional perspective, the article 100, when configured as a substrate, can be flat or planar, or it can be curved and/or sharply-bent. Similarly, the strengthened glass article 100 can be a single unitary object, a multi-layered structure, or a laminate. When the article 100 is employed in a substrate or plate-like form, the thickness of the article 100 is preferably in the range of about 0.2 to 1.5 mm, and more preferably in the range of about 0.8 to 1 mm. Further, the article 100 can possess a composition that is substantially transparent in the visible spectrum, and which remains substantially transparent after the development of its compressive stress region 50.

Regardless of its composition or physical form, the strengthened glass article 100, as depicted in FIG. 1, will include a compressive stress region 50 under compressive stress that extends inward from a surface (e.g., first and second primary surfaces 12, 14) to a specific depth therein (e.g., the first and second selected depths 52, 54). The amount of compressive stress (CS) and the depth of compressive stress layer (DOL) associated with the compressive stress region 50 can be varied based on the particular use for the strengthened glass articles 100, e.g., as formed according to the methods 200-400 depicted in FIGS. 2-4. One general limitation, particularly for a strengthened glass article 100 having a glass composition, is that the CS and DOL should be limited such that a tensile stress created within the bulk of the article 100, as a result of the compressive stress region 50, does not become so excessive as to render the article frangible. In some implementations, the portions of the compressive stress region 50 in the strengthened glass article 100 that extend from the first and second primary surfaces 12 and 14, respectively, are substantially symmetric (e.g., in regard to their compressive stress profile of CS versus depth). In other implementations, the portions of the compressive stress region 50 in the strengthened glass article 100 that extend from the first and second primary surfaces 12 and 14, respectively, are substantially asymmetric. In these implementations, the portions of the compressive stress region 50 that extend from the first and second primary surfaces 12 and 14, respectively, differ from one another in terms of their compressive stress profile of CS versus depth. Further, in certain of these implementations, the portions of the compressive stress region 50 that extend from the first and second primary surfaces 12 and 14, respectively, differ from one another in terms of their amounts of ion-exchanged ions—e.g., as resulting from a chemical strengthening process.

In certain aspects of the disclosure, compressive stress (CS) profiles of strengthened glass articles 100 having a glass composition, e.g., that were strengthened using an ion exchange process according to the methods 200-400 shown in FIGS. 2-4 and described below, were determined using a method for measuring the stress profile based on the TM and TE guided mode spectra of the optical waveguide formed in the ion-exchanged glass (hereinafter referred to as the “WKB method”). The method includes digitally defining positions of intensity extrema from the TM and TE guided mode spectra, and calculating respective TM and TE effective refractive indices from these positions. TM and TE refractive index profiles nTM(z) and nTE(z) are calculated using an inverse WKB calculation. The method also includes calculating the stress profile S(z)=[n_{TM}(z)−n_{TM}(z)]/SOC, where SOC is a stress optic coefficient for the glass substrate. This method is described in U.S. patent application Ser. No. 13/463,322 by Douglas C. Allan et al., entitled “Systems and Methods for Measuring the Stress Profile of Ion-Exchanged Glass,” filed May 3, 2012, and claiming priority to U.S. Provisional Patent Application No. 61/489,800, filed May 25, 2011, the contents of which are incorporated herein by reference in their entirety. Other techniques for measuring stress levels in these articles as a function of depth are outlined in U.S. Provisional Patent Application Nos. 61/835,823 and 61/860,560, hereby incorporated by reference.

According to an embodiment of the strengthened glass article 100 depicted in FIG. 1, the glass article is characterized by a change in haze (Δ haze) and/or gloss (Δ gloss) of less than about 15%, less than about 10% or less than about 5%, as measured before and after the formation of the compressive stress region 50, anti-glare surface 70 and etched first primary surface 12′. In some implementations, the strengthened glass article 100 is characterized by a change in haze (Δ haze) and/or change in gloss (Δ gloss) of less than about 15%, less than about 14%, less than about 13%, less than about 12%, less than about 11%, less than about 10%, less than about 9%, less than about 8%, less than about 7%, less than about 6%, less than about 5%, less than about 4%, less than about 3%, less than about 2%, less than about 1%, less than about 0.75%, less than about 0.5%, less than about 0.25%, and all change in haze (Δ haze) and/or gloss (Δ gloss) values between the levels, as measured before and after the formation of the compressive stress region 50, anti-glare surface 70 and etched first primary surface 12′.

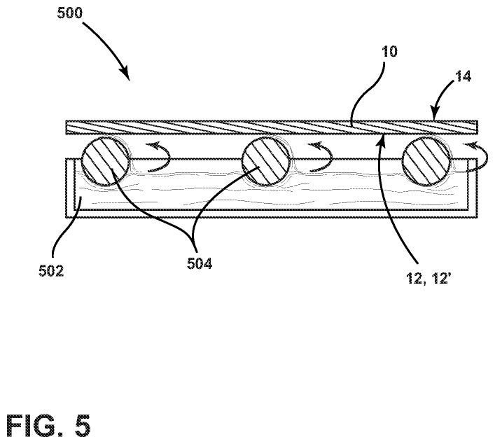

Referring now to FIG. 2, a schematic illustration of a method 200 of making strengthened articles 100a is provided. The method 200 of making strengthened articles 100a includes a step 202 of providing an article, e.g., a substrate 10 (i.e., as shown in FIG. 1 and outlined in its corresponding description above), comprising a glass, glass-ceramic or ceramic composition with a plurality of ion-exchangeable alkali metal ions, a first primary surface 12 and a second primary surface 14. The method 200 depicted in FIG. 2 also includes a step 204 of etching the first primary surface 12 with an etchant having a pH of less than 7 (e.g., an aqueous solution of 15 wt % HF and 20 wt % HCl) to form an etched first primary surface 12′. In some embodiments of the method 200, the etching step 204 can be conducted with a sponge-rolling apparatus (e.g., sponge-rolling apparatus 500 depicted in FIG. 5, as described below) configured to form an etched first primary surface 12′ by direct contact of etchant-laden rollers (e.g., roller 504 shown in FIG. 5) with the first primary surface 12 of the substrate 10. In some implementations of the method 200, the etching step 204 can be conducted by masking the second primary surface 14 with a masking film (not shown in FIG. 2) and submersing the masked substrate 10 into an etchant batch to form the etched first primary surface 12′ from the first primary surface 12 of the substrate 10. In another implementation of the method 200, the etching step 204 can be conducted by etching both of the first and second primary surfaces 12, 14, resulting in an etched first primary surface 12′ and an etched second primary surface (not shown). Other approaches for etching the first primary surface 12 of the substrate 10 according to step 204 can be conducted according to the foregoing principles, as understood by those of ordinary skill in the field of the disclosure (e.g., wet etching, dipping, spraying and/or rolling with the etchant).

Referring again to the method 200 of making strengthened articles 100a depicted in FIG. 2, the method includes a step 206 of forming an anti-glare surface 70 integral with the second primary surface 14, the forming step conducted after masking the first primary surface 12 with a masking film 82. Various films can be employed for the masking film 82, such as a polyethylene film, provided that the thickness and composition of the film can ensure that the etchants employed in the formation of the anti-glare surface 70 are inhibited from contact with the first primary surface 12 during step 206. The anti-glare surface 70 is configured, e.g., through etching (e.g., an aqueous solution of HF and HCl with a salt, such as NaCl), with a morphology such that the strengthened glass article 100a is characterized by anti-glare properties as understood by those of ordinary skill in the field of the disclosure. Various etchant solutions can be employed to prepare the anti-glare surface 70 that comprise an acid along with one or more of alkali ions, ammonium ions, organic additives and inorganic additives. Suitable etchant solutions for developing the anti-glare surface 70 include those provided in U.S. Pat. No. 8,778,496, issued Jul. 15, 2014, and U.S. Patent Application Publication No. 2010/0246016, published on Sep. 30, 2010, the salient portions of which related to etchants and processes for forming anti-glare surfaces are hereby incorporated by reference within this disclosure.

The method 200 depicted in FIG. 2 also includes a step 208 of removing the masking film 82 from the first primary surface 12. In embodiments of the method 200, the step 208 of removing the masking film 82 can be conducted manually, through an automated process for removing the film 82, or another process, depending on the composition of the film 82 and its adhesion to the first primary surface 12 of the substrate 10.

Still referring to the method 200 of making strengthened articles 100a depicted in FIG. 2, the method also includes a step 210 of providing a first ion-exchange bath (not shown) comprising a plurality of ion-exchanging alkali metal ions, each having a larger size than the size of the ion-exchangeable alkali metal ions. The method 200 further includes a step 212 of submersing the substrate 10 in the first ion-exchange bath at a first ion-exchange temperature and duration to form a strengthened article 100a. Upon the completion of the step 212 of the method 200, the strengthened article 100a comprises a compressive stress region 50 extending from the etched first primary surface 12′ and the second primary surface 14 to first and second selected depths 52 and 54, respectively.

Referring again to the method 200 of making strengthened articles 100a depicted in

FIG. 2, the method can be conducted according to various sequences, including, but not limited to, those denoted by “A” and “B” in FIG. 2. In the sequence denoted by “A”, the step 204 of etching the first primary surface 12 with an etchant having a pH of less than 7 to form an etched first primary surface 12′ is conducted prior to the step 206 of forming an anti-glare surface 70 integral with the second primary surface 14. Accordingly, the step 206 is conducted after masking the etched first primary surface 12′ (i.e., as formed in the prior step 204) with a masking film 82—i.e., to protect the etched first primary surface 12′ from the process used to form the anti-glare surface 70. In the sequence denoted by “B”, steps 206 and 208 of the method 200 are conducted prior to the step 204. That is, according to the method 200 as denoted by “B”, the step 206 of forming an anti-glare surface 70 integral with the second primary surface 14 is conducted after the step 202 of providing the substrate 10. As noted earlier, the forming step 206 is conducted after masking the first primary surface 12 of the substrate 10 with a masking film 82. After completion of step 206, the step 208 of removing the masking film 82 from the first primary surface 12 is conducted. At this point, the anti-glare surface 70 has been formed integral with the second primary surface 14 (i.e., as the result of steps 206 and 208), and step 204 is conducted. In this sequence, step 204 is conducted to etch the first primary surface 12 with an etchant having a pH of less than 7 to form an etched first primary surface 12′. It should be understood that this sequence may require masking of the anti-glare surface 70 with a masking film (comparable in composition to masking film 82) during step 204 to ensure that the etching process does not damage the anti-glare surface 70, particularly if step 204 is conducted by dip-coating the substrate 10 into a bath of the etchant. Conversely, if step 204 is conducted with an etching process that ensures direct contact of the etchant to the first primary surface 12 without contact to the anti-glare surface 70 (e.g., by using the sponge-rolling apparatus 500 depicted in FIG. 5 and detailed below), masking of the anti-glare surface 70 will not be necessary.

Referring again to the method 200 of making strengthened articles 100a depicted in FIG. 2, the step 204 of etching the first primary surface 12 to form an etched first primary surface 12′ can be conducted with various etchants having a pH of 7 or less. Suitable etchants include, but are not limited to, HF, HCl, NaF, H₃PO₄, H₂SO₄, NH₄HF₂, HNO₃, NH₄F, NaF, and combinations thereof. Further, the etching step 204 can be conducted at ambient temperature, or elevated temperatures above ambient temperature. Depending on the particular process employed in step 204, the etchant can be held in a bath within a vessel. The vessel can be suitable for dip-coating of the substrate 10, wicking onto rollers of a sponge-rolling apparatus (e.g., rollers 504 of the apparatus 500 depicted in FIG. 5), etc.

Referring once again to the method 200 depicted in FIG. 2, the step 206 of forming an anti-glare (AG) surface 70 integral can be conducted according to various sequences and processes. Various etchant solutions can be employed in a dipping, spraying or rolling process to prepare the AG surface 70, including those comprising a mixture of hydrofluoric acid and a mineral acid along with one or more of salts containing alkali and/or ammonium ions as well as organic and inorganic additives. Typically, a cleaning step can be conducted prior to step 206 by using a mixture of hydrofluoric acid and a mineral acid. Further, a post-AG surface cleaning/polishing step can be applied to achieve the desirable optical properties of the AG surface 70 by using a mixture of hydrofluoric acid and a mineral acid whose concentrations are dictated by the optical property targets of the AG surface 70.

Still referring to the method 200 of making strengthened articles 100a depicted in FIG. 2, the strengthened articles 100a produced according to the method exhibit little to no warp. According to some embodiments, the strengthened glass article 100a, formed according to the method 200, is characterized by a change in warp (Δ warp) of about 200 microns or less, as measured before and after the formation of the compressive stress region 50, anti-glare surface 70 and etched first primary surface 12′. In some implementations, the change in warp (Δ warp) of the article 100a is about 300 microns or less, about 250 microns or less, about 200 microns or less, about 175 microns or less, about 150 microns or less, about 125 microns or less, about 100 microns or less, about 90 microns or less, about 80 microns or less, about 70 microns or less, about 60 microns or less, about 50 microns or less, about 40 microns or less, about 30 microns or less, about 20 microns or less, about 10 microns or less, and all change in warp (Δ warp) levels between these levels—i.e., as measured before and after the formation of the compressive stress region 50, anti-glare surface 70 and etched first primary surface 12′. Similarly, the strengthened glass articles 100a can exhibit a maximum warpage of less than 0.5% of the longest dimension of the article 100a, less than 0.1% of the longest dimension of the article 100a, or even less than 0.01% of the longest dimension of the article 100a.

Once again referring to the method 200 depicted in FIG. 2, the strengthened glass articles 100a formed according to the method 200 can be characterized by a change in haze (Δ haze) and/or gloss (Δ gloss) of less about 15%, less than about 10% or less than about 5%, as measured before and after the formation of the compressive stress region 50, anti-glare surface 70 and etched first primary surface 12′. In some implementations, the strengthened glass article 100a, as formed according to the method 200, is characterized by a change in haze (Δ haze) and/or change in gloss (Δ gloss) of less than about 15%, less than about 14%, less than about 13%, less than about 12%, less than about 11%, less than about 10%, less than about 9%, less than about 8%, less than about 7%, less than about 6%, less than about 5%, less than about 4%, less than about 3%, less than about 2%, less than about 1%, less than about 0.75%, less than about 0.5%, less than about 0.25%, and all change in haze (Δ haze) and/or gloss (Δ gloss) values between the levels, as measured before and after the formation of the compressive stress region 50, anti-glare surface 70 and etched first primary surface 12′.

Referring again to the method 200 depicted in FIG. 2 and without being bound by theory, it is evident that the presence of the etched first primary surface 12′ ensures that the rates of ion-exchange occurring at the first primary surface 12 of the substrate 10 do not substantially differ from the ion-exchange rates occurring at the second primary surface 14 comprising an anti-glare surface 70. Indeed, the variability in the surface morphology (e.g., surface roughness) associated with the anti-glare surface 70 can result in a variability of ion-exchange rates into the substrate relative to the opposing surface that does not possess an anti-glare surface 70 (e.g., the first primary surface 12). Without the correction or adjustment to the ion-exchange rate at the first primary surface provided by the method 200 in the form of the etched first primary surface 12′, significant warp would otherwise develop in the substrate 10 after completion of the ion-exchange strengthening process. Accordingly, the method 200 facilitates the development of an etched primary surface opposite to the anti-glare surface 70 that can be tailored to ensure that the substrate 10 does not experience significant warp after completion of an ion-exchange strengthening step. Notably, the etched surface can be adjusted in view of the particular morphology of the anti-glare surface 70 to ensure that the resulting strengthened article 100a does not experience significant warp after completion of the ion-exchange strengthening step.

Referring once again to the method 200 depicted in FIG. 2, the step 212 of submersing the substrate 10 in the first ion-exchange bath at a first ion-exchange temperature and duration to form a strengthened article 100a can be conducted according to various ion-exchange process conditions to develop the compressive stress region 50. In embodiments of the method 200 and step 212, the first ion-exchange bath contains a plurality of ion-exchanging metal ions and the substrate 10 has a glass composition with a plurality of ion-exchangeable metal ions. For example, the bath may contain a plurality of potassium ions that are larger in size than ion-exchangeable ions in the substrates 10, such as sodium. The ion-exchanging ions in the first ion-exchange bath will preferentially exchange with the ion-exchangeable ions in the substrate 10 during step 212. In certain aspects of the method 200 and step 212 depicted in FIG. 2, the first ion-exchange bath employed to create the compressive stress region 50 comprises a molten KNO₃ bath at a concentration approaching 100% by weight with additives, as understood by those with ordinary skill in the field, or at a concentration of 100% by weight. Such a bath is sufficiently heated to a temperature to ensure that the KNO₃ remains in a molten state during processing of the substrates 10. The first ion-exchange bath may also include a combination of KNO₃ and one or both of LiNO₃ and NaNO₃.

According to some aspects of the disclosure, the method 200 for making a strengthened article 100a depicted in FIG. 2 is conducted to develop a compressive stress region 50 in strengthened glass articles 100a with a maximum compressive stress of about 400 MPa or less and a first and second selected depth 52 and 54, respectively, of at least 8% of the thickness of the article 100a. In embodiments of the method 200, the strengthened glass article 100a comprises a substrate 10 having an alumino-silicate glass composition and step 212 is conducted such that it entails submersing the substrate 10 in a first ion-exchange bath held at a temperature in a range from about 400° C. to 500° C. with a submersion duration between about 3 and 60 hours. More preferably, the compressive stress region 50 can be developed in the strengthened article 100a by submersing the substrate 10 in a strengthening bath at a temperature ranging from about 420° C. to 500° C. for a duration between about 0.25 to about 50 hours. In certain aspects, an upper temperature range for the first ion-exchange bath is set to be about 30° C. less than the anneal point of the substrate 10 (e.g., when the substrate 10 possesses a glass or a glass-ceramic composition). Particularly preferable durations for the submersion step 212 range from 0.5 to 25 hours. In certain embodiments, the first ion-exchange bath is held at about 400° C. to 450° C., and the first ion exchange duration is between about 3 and 15 hours.

In one exemplary aspect of the method 200 depicted in FIG. 2, step 212 is conducted such that the substrate 10 is submersed in a first ion-exchange bath at 450° C. that includes about 41% NaNO₃ and 59% KNO₃ by weight for a duration of about 10 hours to obtain a compressive stress region 50 with a DOL>80 μm and a maximum compressive stress of 300 MPa or less (e.g., for a strengthened article 100a having a thickness about 0.8 to 1 mm). In another example, the first ion-exchange bath includes about 65% NaNO₃ and 35% KNO₃ by weight held at 460° C., and the submersion step 212 is conducted for about 40 to 50 hours to develop a compressive stress region 50 with a maximum compressive stress of about 160 MPa or less with a DOL of about 150 μm or more (e.g., for a strengthened glass article 100a having a thickness of about 0.8 mm).

For alumino-silicate glass substrates 10 having a thickness of about 0.3 to 0.8 mm, a DOL>60 μm can be achieved in strengthened glass articles 100a made according to the method 200 depicted in FIG. 2 with a first ion-exchange bath 200 composition in the range of 40 to 60% NaNO₃ by weight (with a balance being KNO₃) held at a temperature of 450° C. with a submersion duration between about 5.5 to 15 hours. Preferably, the submersion duration according to step 212 of the method 200 is between about 6 to 10 hours and the first ion exchange bath is held at a composition in the range of 44 to 54% NaNO₃ by weight (with a balance KNO₃).

For embodiments of the method 200 of making strengthened glass articles 100a depicted in FIG. 2, in which the strengthened articles 100a are derived from substrates 10 containing alumino-silicate glass with appreciable amounts of P₂O₅, the first ion exchange bath can be held at somewhat lower temperatures to develop a similar compressive stress region 50. For example, the first ion exchange bath can be held as low as 380° C. with similar results, while the upper range outlined in the foregoing remains viable. In a further aspect, the substrates 10 may possess a lithium-containing glass composition and appreciably lower temperature profiles can be employed, according to the method 200 depicted in FIG. 2, to generate a similar compressive stress region 50 in the resulting strengthened articles 100a. In these aspects, the first ion exchange bath is held at a temperature ranging from about 350° C. to about 500° C., and preferably from about 380° C. to about 480° C. The submersion times for these aspects range from about 0.25 hours to about 50 hours and, more preferably, from about 0.5 to about 25 hours.

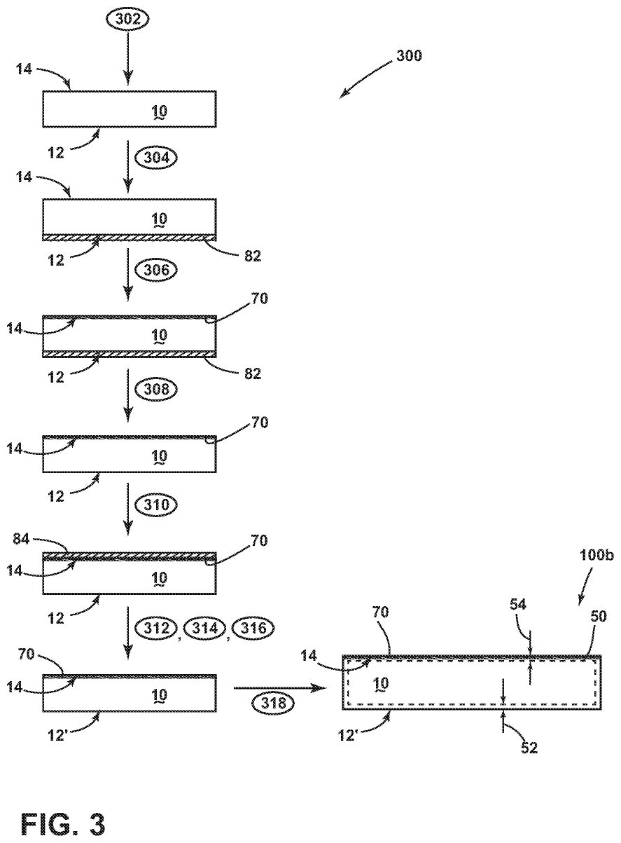

Referring now to FIG. 3, a method 300 of making a strengthened glass article 100b is provided. Unless otherwise noted, the properties and attributes of the strengthened glass articles 100b (e.g., A warp, A haze, A gloss, CS, DOL, etc.) are the same as or substantially similar to those of the strengthened glass articles 100 (see FIG. 1 and corresponding description above) and the strengthened glass articles 100a formed by the method 200 (see FIG. 2 and corresponding description above). Accordingly, like-numbered elements in the strengthened glass articles 100b of FIG. 3 have the same or substantially similar structure and function as the same elements depicted in FIGS. 1 and 2 for the strengthened glass articles 100 and 100a, respectively.

As for the method 300 of making strengthened glass articles 100b depicted in FIG. 3, the method includes a step 302 of providing an article, e.g., a substrate 10 (i.e., as shown in FIG. 1 and outlined in its corresponding description above), comprising a glass, glass-ceramic or ceramic composition with a plurality of ion-exchangeable alkali metal ions, a first primary surface 12 and a second primary surface 14. Referring again to the method 300 of making a strengthened article 100b depicted in FIG. 3, the method includes a step 304 of masking the first primary surface 12 with a first masking film 82. Various films can be employed for the masking film 82, such as a polyethylene film, provided that the thickness and composition of the film can ensure that the etchants employed in the formation of the anti-glare surface 70 are inhibited from contact with the first primary surface 12 during the subsequent step 306. Suitable masking films that can be employed for masking film 82 are surface protective films such as: low density polyethylene (LDPE) type 311 film, as sourced from Surface Armor® LLC; and polyethylene terephthalate (PET) ANT-200 film, as sourced from Seil Hi-Tec Co., Ltd.

Still referring to the method 300 of making a strengthened glass article 100b depicted in FIG. 3, the method further includes a step 306 of forming an anti-glare (AG) surface 70 integral with the second primary surface 14, the forming step conducted after the masking step 304. The anti-glare surface 70 is configured, e.g., through etching (e.g., an aqueous solution of HF and HCl with a salt, such as NaCl), with a morphology such that the strengthened glass article 100b is characterized by anti-glare properties as understood by those of ordinary skill in the field of the disclosure (and as described earlier in connection with step 206 of the method 200 depicted in FIG. 2). Further, the method 300 depicted in FIG. 3 also includes a step 308 of removing the masking film 82 from the first primary surface 12. In embodiments of the method 300, the step 308 of removing the masking film 82 can be conducted manually, through an automated process for removing the film 82, or another process, depending on the composition of the film 82 and its adhesion to the first primary surface 12 of the substrate 10.

Once again referring to the method 300 of making a strengthened glass article 100b depicted in FIG. 3, the method includes a step 310 of masking the anti-glare surface 70 (i.e., as formed in step 306) with a second masking film 84. The second masking film 84 can comprise a polyethylene film or other comparable film consistent with the first masking film 82, provided that the thickness and composition of the film 84 ensures that the etchant employed in the subsequent step 312 of etching the first primary surface 12 does not remove or otherwise degrade the anti-glare surface 70 (i.e., as formed in step 306).

The method 300 depicted in FIG. 3 also includes a step 312 of etching the first primary surface 12 with an etchant having a pH of less than 7 (e.g., an aqueous solution of 15 wt % HF and 20 wt % HCl) to form an etched first primary surface 12′. In some implementations of the method 300, the etching step 312 can be conducted by submersing the masked substrate 10 (e.g., as masked by step 310, which disposes a masking film 84 over the anti-glare surface 70) into an etchant bath to form the etched first primary surface 12′ from the first primary surface 12 of the substrate 10. In some embodiments of the method 300 depicted in FIG. 3, the etching step 312 can be conducted with a sponge-rolling apparatus (e.g., sponge-rolling apparatus 500 depicted in FIG. 5, as described below) configured to form an etched first primary surface 12′ by direct contact of etchant-laden rollers (e.g., roller 504 shown in FIG. 5) with the first primary surface 12 of the substrate 10. According to these embodiments, step 310 is optional as the presence of the masking film 84 over the anti-glare surface 70 is not required. Other approaches for etching the first primary surface 12 of the substrate 10 according to step 312 can be conducted according to the foregoing principles, as understood by those of ordinary skill in the field of the disclosure (e.g., wet etching, dipping, spraying and/or rolling with the etchant). Further, the method 300 depicted in FIG. 3 also includes a step 314 of removing the second masking film 84 from the second primary surface 14 and anti-glare surface 70. In embodiments of the method 300, the step 314 of removing the masking film 84 can be conducted manually, through an automated process for removing the film 84, or another process, depending on the composition of the film 84 and its adhesion to the second primary surface 14 and/or anti-glare surface 70 of the substrate 10. The method 300 of making a strengthened glass article 100b depicted in FIG. 3 also includes a step 316 of providing a first ion-exchange bath (not shown) comprising a plurality of ion-exchanging alkali metal ions, each having a larger size than the size of the ion-exchangeable alkali metal ions.

Still referring to the method 300 of making a strengthened article 100b, the method 300 can conclude with a step 318 of submersing the substrate 10 in the first ion-exchange bath at a first ion-exchange temperature and duration to form a strengthened article 100b. Upon the completion of the step 318 of the method 300, the strengthened article 100b comprises a compressive stress region 50 extending from the etched first primary surface 12′ and the second primary surface 14 to first and second selected depths 52 and 54, respectively. Further, step 318 can be conducted the same as, or substantially similar to, the step 212 of the method 200 (see FIG. 2 and corresponding description above).

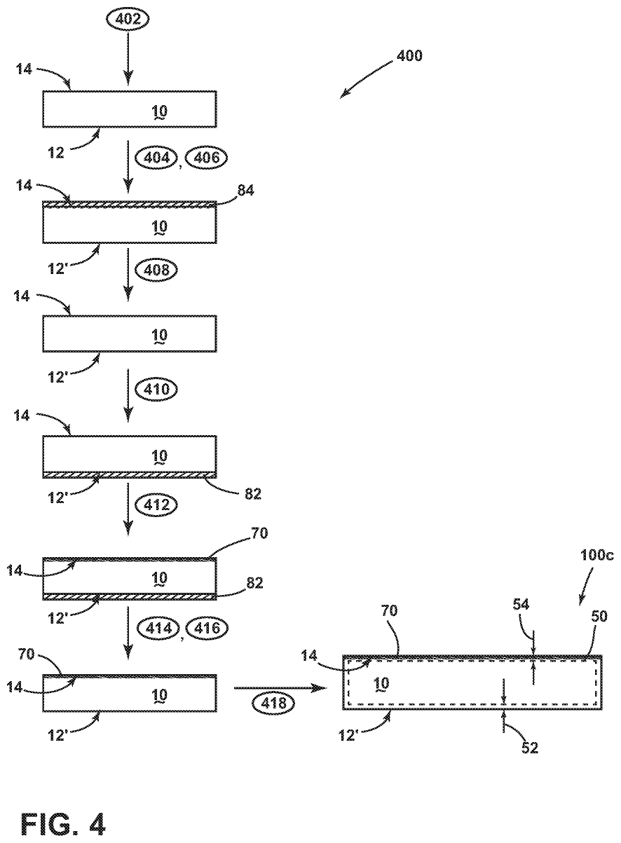

Referring now to FIG. 4, a method 400 of making a strengthened glass article 100c is provided. Unless otherwise noted, the properties and attributes of the strengthened glass articles 100c (e.g., Δ warp, Δ haze, Δ gloss, CS, DOL, etc.) are the same as or substantially similar to those of the strengthened glass articles 100 (see FIG. 1 and corresponding description above), the strengthened glass articles 100a formed by the method 200 (see FIG. 2 and corresponding description above) and the strengthened glass articles 100b formed by the method 300 (see FIG. 3 and corresponding description above). Accordingly, like-numbered elements in the strengthened glass articles 100c of FIG. 4 have the same or substantially similar structure and function as the same elements depicted in FIGS. 1-3 for the strengthened glass articles 100, 100a and 100b, respectively.

As for the method 400 of making strengthened glass articles 100c depicted in FIG. 4, the method includes a step 402 of providing an article, e.g., a substrate 10 (i.e., as shown in FIG. 1 and outlined in its corresponding description above), comprising a glass, glass-ceramic or ceramic composition with a plurality of ion-exchangeable alkali metal ions, a first primary surface 12 and a second primary surface 14. Referring again to the method 400 of making a strengthened article 100c depicted in FIG. 4, the method includes a step 404 of masking the second primary surface 14 with a second masking film 84. Various films can be employed for the masking film 84, such as a polyethylene film, provided that the thickness and composition of the film can ensure that the etchants employed in the formation of the etched first primary surface 12′ are inhibited from contact with the second primary surface 14 during the subsequent step 406. The method 400 depicted in FIG. 4 also includes a step 406 of etching the first primary surface 12 with an etchant having a pH of less than 7 (e.g., an aqueous solution of 15 wt % HF and 20 wt % HCl) to form an etched first primary surface 12′. In some implementations of the method 400, the etching step 406 can be conducted by submersing the masked substrate 10 (e.g., as masked by step 404, which disposes a second masking film 84 over the second primary surface 14) into an etchant bath to form the etched first primary surface 12′ from the first primary surface 12 of the substrate 10. In some embodiments of the method 400 depicted in FIG. 4, the etching step 406 can be conducted with a sponge-rolling apparatus (e.g., sponge-rolling apparatus 500 depicted in FIG. 5, as described below) configured to form an etched first primary surface 12′ by direct contact of etchant-laden rollers (e.g., roller 504 shown in FIG. 5) with the first primary surface 12 of the substrate 10. According to these embodiments, step 404 is optional as the presence of the second masking film 84 over the second primary surface 14 is not required. Other approaches for etching the first primary surface 12 of the substrate 10 according to step 406 can be conducted according to the foregoing principles, as understood by those of ordinary skill in the field of the disclosure (e.g., wet etching, dipping, spraying and/or rolling with the etchant).

Further, the method 400 depicted in FIG. 4 also includes a step 408 of removing the second masking film 84 from the second primary surface 14. In embodiments of the method 400, the step 408 of removing the masking film 84 can be conducted manually, through an automated process for removing the film 84, or another process, depending on the composition of the film 84 and its adhesion to the second primary surface 14 of the substrate 10. Referring again to the method 400 of making a strengthened article 100c depicted in FIG. 4, the method includes a step 410 of masking the first primary surface 12 and etched first primary surface 12′ with a first masking film 82. Various films can be employed for the masking film 82, such as a polyethylene film, provided that the thickness and composition of the film can ensure that the etchants employed in the formation of the anti-glare surface 70 are inhibited from contact with the first primary surface 12 and etched first primary surface 12′ during the subsequent step 412.

Still referring to the method 400 of making a strengthened glass article 100c depicted in FIG. 4, the method further includes a step 412 of forming an anti-glare surface 70 integral with the second primary surface 14, the forming step conducted after the masking step 410. The anti-glare surface 70 is configured, e.g., through etching (e.g., an aqueous solution of HF and HCl with a salt, such as NaCl), with a morphology such that the strengthened glass article 100c is characterized by anti-glare properties as understood by those of ordinary skill in the field of the disclosure (and as described earlier in connection with step 206 of the method 200 depicted in FIG. 2).

Further, the method 400 depicted in FIG. 4 also includes a step 414 of removing the first masking film 82 from the first primary surface 12 and etched first primary surface 12′. In embodiments of the method 400, the step 414 of removing the masking film 82 can be conducted manually, through an automated process for removing the film 82, or another process, depending on the composition of the film 82 and its adhesion to the first primary surface 12 and etched first primary surface 12′ of the substrate 10. The method 400 of making a strengthened glass article 100c depicted in FIG. 4 also includes a step 416 of providing a first ion-exchange bath (not shown) comprising a plurality of ion-exchanging alkali metal ions, each having a larger size than the size of the ion-exchangeable alkali metal ions.

Still referring to the method 400 of making a strengthened article 100c, the method 400 can conclude with a step 418 of submersing the substrate 10 in the first ion-exchange bath at a first ion-exchange temperature and duration to form a strengthened article 100c. Upon the completion of the step 418 of the method 400, the strengthened article 100c comprises a compressive stress region 50 extending from the etched first primary surface 12′ and the second primary surface 14 to first and second selected depths 52 and 54, respectively. Further, step 418 can be conducted the same as, or substantially similar to, the step 212 of the method 200 (see FIG. 2 and corresponding description above).

Referring now to FIG. 5, a sponge-rolling apparatus 500 is depicted that can be employed in the methods 200-400 (see FIGS. 2-4 and their corresponding description above). As shown in FIG. 5, the sponge-rolling apparatus 500 includes a plurality of sponge rollers 504 that spin within a reservoir 502, the reservoir containing an etchant. As the substrate 10 passes over the rollers 504, the etchant from the reservoir 502 is placed in direct contact with the first primary surface 12 to form an etched first primary surface 12′. Notably, the sponge-rolling apparatus 500 ensures that the etchant from the reservoir 502 is not placed in contact with the second primary surface 14 or anti-glare surface 70, if present (not shown). As outlined earlier, the sponge-rolling apparatus 500 can be employed in steps 204, 312 and 406 of the methods 200, 300 and 400 of making strengthened articles 100a, 100b, and 100c, respectively (see FIGS. 2-4). As consistent with the principles of this disclosure, the sponge-rolling apparatus 500 depicted in FIG. 5 could be employed in other steps of the methods 200, 300 and 400, including, for example, the steps of forming an anti-glare surface integral with the second primary surface 14 (e.g., steps 206, 306 and 412).

### EXAMPLES

The following examples describe various features and advantages provided by the disclosure, and are in no way intended to limit the invention and appended claims.

### Example 1

In this example, groups of Corning® Gorilla® Glass 3 substrate samples (n=5 per group) were prepared and subjected to methods of making strengthened articles according to principles and concepts of the disclosure (e.g., the methods 200-400 of making strengthened articles 100a-c depicted in FIGS. 2-4). In particular, the substrates were sectioned into samples having dimensions of 443 mm×300 mm×1.1 mm, 366 mm×137 mm×1.1 mm, or 344 mm×151 mm×1.1 mm, as shown below in Table 1. After preparation of anti-glare surfaces and/or etched primary surfaces, as noted in detail below (see below for the descriptions of Exs. 1-1 to 1-6 and Comp. Exs. 1-1 to 1-6), each group of these samples was subjected to ion-exchange conditions in which the samples were immersed in a bath of 100% KNO₃ at 420° C. for 6 hours.

As detailed below in Table 1, a group of five (5) samples denoted Ex. 1-1 was subjected to a method of strengthening an article consistent with the method 300 (see FIG. 3 and corresponding description). In particular, one of the primary surfaces of each substrate in this group was laminated using an acid-resistant film (polyethylene) and the opposing surface was subjected to a process for making an integral anti-glare (AG) surface, consistent with those outlined earlier in the disclosure. The lamination film was then removed from the non-AG surface, and then a separate acid-resistant lamination film was applied to the newly-formed AG surface, consistent with those outlined earlier in the disclosure. The lamination film was then removed from the non-AG surface, and then a separate acid-resistant lamination film was applied to the newly-formed AG surface. The non-AG surface was then subjected to an etching process for 2 minutes at 20° C. in an aqueous solution containing 15 wt % HF and 20 wt % HCl. After this second lamination film was removed, the samples were then subjected to the ion-exchange (IOX) process noted earlier (i.e., 100% KNO₃ at 420° C. for 6 hours). In addition, a control group of five samples (5) denoted Comp. Ex. 1-1 was subjected to these same process conditions, including the ion-exchange process step, except that the AG surface was not masked and the non-AG surface was not subjected to an etching process.

As also detailed below in Table 1, a group of five (5) samples denoted Ex. 2-1 was subjected to a method of strengthening an article consistent with the method 400 (see FIG. 4 and corresponding description). In particular, one of the primary surfaces of each substrate in this group was laminated (i.e., the surface that will become an AG surface) using an acid-resistant film (polyethylene) and the opposing surface was subjected to an etching process for 4 minutes at 20° C. in an aqueous solution containing 15 wt % HF and 20 wt % HCl. After the etching step was completed, the acid-resistant film was removed and a separate acid-resistant lamination film was applied to the newly-formed etched primary surface. At this point, the prior-masked surface was subjected to a process for making an integral anti-glare (AG) surface, consistent with those outlined earlier in the disclosure. Next, the acid-resistant lamination film over the prior-etched surface was removed. Finally, the samples were subjected to the ion-exchange process noted earlier (i.e., 100% KNO₃ at 420° C. for 6 hours). In addition, a control group of five samples (5) denoted Comp. Ex. 2-1 was subjected to these same process conditions, including the ion-exchange process step, except that the step of masking the surface that will become the AG surface was not conducted. Accordingly, both primary surfaces were etched, and then an AG surface was formed on one of these surfaces in the group of samples denoted Comp. Ex. 2-1.

Again referring to Table 1, a group of five (5) samples denoted Ex. 3-1 was subjected to a method of strengthening an article consistent with the method 300 (see FIG. 3 and corresponding description). In particular, one of the primary surfaces of each substrate in this group was laminated using an acid-resistant film (polyethylene) and the opposing surface was subjected to a process for making an integral anti-glare (AG) surface, consistent with those outlined earlier in the disclosure. The lamination film was then removed from the non-AG surface, and then a separate acid-resistant lamination film was applied to the newly-formed AG surface. The non-AG surface was then subjected to an etching process for 4 minutes at 20° C. in an aqueous solution containing 15 wt % HF and 20 wt % HCl. After this second lamination film was removed, the samples were then subjected to the ion-exchange process noted earlier (i.e., 100% KNO₃ at 420° C. for 6 hours). In addition, a control group of five samples (5) denoted Comp. Ex. 3-1 was subjected to these same process conditions, including the ion-exchange process step, except that the step of masking the AG surface was not conducted. Accordingly, both primary surfaces were etched in a single step, and then the AG surface was formed integral with one of these surfaces in the group of samples denoted Comp. Ex. 3-1.

Also referring to Table 1, a group of five (5) samples denoted Ex. 4-1 was subjected to a method of strengthening an article consistent with the method 300 (see FIG. 3 and corresponding description). In particular, one of the primary surfaces of each substrate in this group was laminated using an acid-resistant film (polyethylene) and the opposing surface was subjected to a process for making an integral anti-glare (AG) surface, consistent with those outlined earlier in the disclosure. The non-AG surface was then subjected to an etching process for 10 minutes at 20° C. in an aqueous solution containing 0.35M NaF and 1M H₃PO₄. After this second lamination film was removed, the samples were then subjected to the ion-exchange process noted earlier (i.e., 100% KNO₃ at 420° C. for 6 hours). In addition, a control group of five samples (5) denoted Comp. Ex. 4-1 was subjected to these same process conditions, including the ion-exchange process step, except that the etching step was not conducted. Accordingly, the AG surface was formed integral with one of the primary surfaces and none of the primary surfaces were etched in the group of samples denoted Comp. Ex. 4-1.

Again referring to Table 1, a group of five (5) samples denoted Ex. 5-1 was subjected to a method of strengthening an article consistent with the method 300 (see FIG. 3 and corresponding description). In particular, one of the primary surfaces of each substrate in this group was laminated using an acid-resistant film (polyethylene) and the opposing surface was subjected to a process for making an integral anti-glare (AG) surface, consistent with those outlined earlier in the disclosure. The lamination film was then removed from the non-AG surface, and then a separate acid-resistant lamination film was applied to the newly-formed AG surface. The non-AG surface was then subjected to an etching process for 20 minutes at 20° C. in an aqueous solution containing 0.35M NaF and 1M H₃PO₄. After this second lamination film was removed, the samples were then subjected to the ion-exchange process noted earlier (i.e., 100% KNO₃ at 420° C. for 6 hours). In addition, a control group of five samples (5) denoted Comp. Ex. 5-1 was subjected to these same process conditions, including the ion-exchange process step, except that the etching step was conducted with the same etchant and temperature, but at a much shorter duration, 2.5 minutes. Accordingly, this group of control samples, Comp. Ex. 5-1, is similar to the Ex. 5-1 group, but the etched primary surface was created with much less aggressive etching conditions.

Finally, as referring to Table 1, a group of five (5) samples denoted Ex. 6-1 was subjected to a method of strengthening an article consistent with the method 400 (see FIG. 4 and corresponding description). In particular, one of the primary surfaces was subjected to a direct etching process using a sponge-rolling apparatus (e.g., as consistent with the sponge-rolling apparatus 500 depicted in FIG. 5 and described earlier) for 326 seconds at 24° C. using an aqueous solution containing 0.35M NaF and 1M H₃PO₄. After the etching step was completed, an acid-resistant lamination film was applied to the newly-formed etched primary surface. At this point, the non-etched surface was subjected to a process for making an integral anti-glare (AG) surface, consistent with those outlined earlier in the disclosure. Next, the acid-resistant lamination film over the prior-etched surface was removed. Finally, the samples were subjected to the ion-exchange process noted earlier (i.e., 100% KNO₃ at 420° C. for 6 hours). In addition, a control group of five samples (5) denoted Comp. Ex. 6-1 was subjected to the ion-exchange described earlier (i.e., 100% KNO₃ at 420° C. for 6 hours), but with no prior steps of masking the primary surfaces, etching the primary surfaces or forming an anti-glare surface integral with these surfaces. Accordingly, the group of samples denoted Comp. Ex. 6-1 represents a control group without any AG and etched primary surfaces.

Warp measurements were made on each of the groups of samples listed in Table 1. In particular, each sample was measured using a deflectometer (ISRA Vision 650×1300 mm system) on both sides before and after the ion-exchange process step. Maximum warp differences (i.e., Δ warp) are reported in Table 1 based on these measurements. As also reported in Table 1, haze and gloss measurements were made on each of the samples in each group before and after the ion-exchange process step. The haze measurements were conducted as transmission haze measurements on a BYK Gardner Haze-Gard haze meter at room temperature according to measurement principles understood by those of ordinary skill in the field of the disclosure. The gloss measurements were conducted on a Rhopoint Instruments gloss meter according to measurement principles understood by those of ordinary skill in the field of the disclosure. Further, change in haze (Δ haze) and change in gloss (Δ gloss) were reported in Table 1, as calculated from the haze and gloss measurements from each group of samples according to these measurement protocols.

TABLE 1

| | Dim. of | | Etching | | | | | |
|---|---|---|---|---|---|---|---|---|
| | samples | | time | Etching | Side(s) | Δ | Δ | Δ |
| Examples | (mm) | Etchant | (min) | process | etched | Warp | Haze | Gloss |
| Ex. 1-1 | 443 × 300 × 1.1 | HF/HCl | 2 | dipping btw | Non-AG | 0.020 | ~0 | ~0 |
| | | | | AG & IOX | | | | |
| Comp. | 443 × 300 × 1.1 | N/A | N/A | N/A | N/A | 0.250 | N/A | N/A |
| Ex. 1-1 | | | | | | | | |
| Ex. 2-1 | 366 × 137 × 1.1 | HF/HCl | 4 | dipping | Non-AG | 0.030 | ~0 | ~0 |
| | | | | before AG | | | | |
| Comp. | 366 × 137 × 1.1 | HF/HCl | 4 | dipping | Both | 0.030 | 4.9 | −24 |
| Ex. 2-1 | | | | before AG | | | | |
| Ex. 3-1 | 366 × 137 × 1.1 | HF/HCl | 4 | dipping btw | Non-AG | −0.020 | ~0 | ~0 |
| | | | | AG & IOX | | | | |
| Comp. | 366 × 137 × 1.1 | HF/HCl | 4 | dipping btw | Both | −0.020 | -0.9 | 8 |
| Ex. 3-1 | | | | AG & IOX | | | | |
| Ex. 4-1 | 344 × 151 × 1.1 | NaF/H₃PO₄ | 10 | dipping btw | Non-AG | −0.002 | ~0 | ~0 |
| | | | | AG & IOX | | | | |
| Comp. | 344 × 151 × 1.1 | None | 0 | N/A | N/A | 0.061 | N/A | N/A |
| Ex. 4-1 | | | | | | | | |
| Ex. 5-1 | 344 × 151 × 1.1 | NaF/H₃PO₄ | 20 | dipping btw | Non-AG | −0.009 | ~0 | ~0 |
| | | | | AG & IOX | | | | |
| Comp. | 344 × 151 × 1.1 | NaF/H₃PO₄ | 2.5 | dipping btw | Non-AG | 0.054 | ~0 | ~0 |
| Ex. 5-1 | | | | AG & IOX | | | | |
| Ex. 6-1 | 344 × 151 × 1.1 | NaF/H₃PO₄ | 5.4 | contact etch | Non-AG | 0.110 | ~0 | *** |
| | | | | before AG | | | | |
| Comp. | 344 × 151 × 1.1 | None | N/A | N/A | N/A. | 0.280 | N/A | N/A |
| Ex. 6-1 | | | | | | | | |

Referring to Table 1, the samples in the Ex. 1-1 group exhibited a change in warp (Δ warp) of about 0.020 mm in comparison to the samples in the Comp. Ex. 1-1 group that exhibited a change in warp (Δ warp) of about 0.250 mm. As such, it is evident that the strengthened glass articles of Ex. 1-1, as produced according to a method consistent with the method 300 (see FIG. 3 and corresponding description above), demonstrated a change in warp of an order of magnitude less than the comparative group, which were processed similarly but without an etched primary surface opposite the AG surface. Further, it is evident that both groups, Ex. 1-1 and Comp. Ex. 1-1, demonstrated comparable, acceptable optical properties (i.e., Δ gloss and Δ haze).

Again referring to Table 1, the samples in the Ex. 2-1 group exhibited a change in warp (Δ warp) of about 0.030 mm in comparison to the samples in the Comp. Ex. 2-1 group that also exhibited a change in warp (Δ warp) of about 0.030 mm. As such, it is evident that the strengthened glass articles of Ex. 2-1, as produced according to a method consistent with the method 400 (see FIG. 4 and corresponding description above), demonstrated a minimal change in warp. The warp levels of the Ex. 2-1 group are comparable to the warp levels exhibited by the comparative group, Comp. Ex. 2-1, which was processed similarly but without masking the surface that was later formed into the AG surface. In contrast, the optical properties of the two groups are significantly different from one another. In particular, it is evident that the comparative group, Comp. Ex. 2-1, which was processed without masking the surface that was later formed into the AG surface, exhibited significantly worse optical properties (i.e., Δ haze of 4.9 and Δ gloss of −24) than the inventive group, Ex. 2-1.

Referring to Table 1, the samples in the Ex. 3-1 group exhibited a change in warp (Δ warp) of about −0.020 mm in comparison to the samples in the Comp. Ex. 3-1 group that also exhibited a change in warp (Δ warp) of about −0.020 mm. As such, it is evident that the strengthened glass articles of Ex. 3-1, as produced according to a method consistent with the method 300 (see FIG. 3 and corresponding description above), demonstrated acceptable warp levels. It is also evident that the warp levels of the Ex. 3-1 group are comparable to the warp levels exhibited by the comparative group, Comp. Ex. 3-1, which was processed similarly but without masking the AG surface prior to the etching step. In contrast, the optical properties of the two groups are significantly different from one another. In particular, it is evident that the comparative group, Comp. Ex. 3-1, which was processed such that both primary surfaces were etched, including the AG surface, exhibited significantly worse optical properties (i.e., Δ haze of −0.9 and Δ gloss of 8) than the inventive group, Ex. 3-1.

Referring again to Table 1, the samples in the Ex. 4-1 group exhibited a change in warp (Δ warp) of about −0.002 mm in comparison to the samples in the Comp. Ex. 4-1 group that exhibited a change in warp (Δ warp) of about 0.061 mm. As such, it is evident that the strengthened glass articles of Ex. 4-1, as produced according to a method consistent with the method 300 (see FIG. 3 and corresponding description above), demonstrated a change in warp of an order of magnitude less than the comparative group, which were processed similarly but without an etching step. In addition, it is evident from Table 1 that the inventive samples in the Ex. 4-1 group exhibited acceptable optical properties without any obvious deterioration to the AG surfaces of these articles, including haze and gloss levels that were not significantly affected by the ion-exchange process.

Again referring to Table 1, the samples in the Ex. 5-1 group exhibited a change in warp (Δ warp) of about −0.009 mm in comparison to the samples in the Comp. Ex. 4-1 group that exhibited a change in warp (Δ warp) of about 0.061 mm. Notably, the samples in the Ex. 5-1 group were processed nearly identical to those in the Ex. 4-1 group, except with an etching time of 20 minutes instead of 10 minutes (Ex. 4-1). As such, it is evident that the strengthened glass articles of Ex. 5-1, as produced according to a method consistent with the method 300 (see FIG. 3 and corresponding description above), demonstrated a change in warp of an order of magnitude less than the comparative group (Comp. Ex. 4-1), which were processed similarly but without an etching step. Nevertheless, samples fabricated nearly identical to those in the Ex. 4-1 and Ex. 5-1 groups, but with a much shorter etching time of 2.5 minutes (Comp. Ex. 5-1) exhibited significantly higher warp levels, Δ warp of 0.054 mm. Hence, it is evident that a lower etching threshold must be achieved in the etched primary surface to offset the effect of the AG surface to prevent warp from the subsequent ion-exchange process. In addition, it is evident from Table 1 that the inventive samples in the Ex. 5-1 group exhibited acceptable optical properties without any obvious deterioration to the AG surfaces of these articles, including haze and gloss levels that were not significantly affected by the ion-exchange process.

Referring again to Table 1, the samples in the Ex. 6-1 group exhibited a change in warp (Δ warp) of about 0.110 mm in comparison to the samples in the Comp. Ex. 6-1 group that exhibited a change in warp (Δ warp) of about 0.280 mm. As such, it is evident that the strengthened glass articles of Ex. 6-1, as produced according to a method consistent with the method 400 (see FIG. 4 and corresponding description above) with direct contact etching, demonstrated a change in warp that is significantly less than the change in warp of the comparative group, which were processed similarly but without an etched primary surface opposite the AG surface. Further, it is evident that both groups, Ex. 6-1 and Comp. Ex. 6-1, demonstrated comparable, acceptable optical properties (i.e., Δ gloss and Δ haze).

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

1. A method of making a strengthened article, comprising:
providing an article comprising a glass, glass-ceramic or ceramic composition with a plurality of ion-exchangeable alkali metal ions, a first primary surface and a second primary surface;
etching the first primary surface with an etchant having a pH of less than 7 to form an etched first primary surface;
forming an anti-glare surface integral with the second primary surface, the forming step conducted after masking the first primary surface with a masking film;
removing the masking film from the first primary surface;
providing a first ion-exchange bath comprising a plurality of ion-exchanging alkali metal ions, each having a larger size than the size of the ion-exchangeable alkali metal ions; and
submersing the article in the first ion-exchange bath at a first ion-exchange temperature and duration to form a strengthened article,
wherein the strengthened article comprises a compressive stress region extending from the etched first primary surface and the second primary surface to first and second selected depths, respectively.

2. The method according to claim 1, wherein the strengthened article comprises a warp (Δ warp) of 50 microns or less, as determined from warp measurements on the article before the submersing step and on the strengthened article after the submersing step.

3. The method according to claim 1, wherein the strengthened article comprises a warp (Δ warp) of 20 microns or less, as determined from warp measurements on the article before the submersing step and on the strengthened article after the submersing step.

4. The method according to claim 1, wherein the etching step is conducted with a sponge-rolling apparatus configured for etching the first primary surface by direct contact with the first primary surface.

5. The method according to claim 1, wherein a change in haze (Δ haze) and change in gloss (Δ gloss) exhibited by the strengthened article is less than 10%, respectively, as determined from haze and gloss measurements on the article before the submersing step and on the strengthened article after the submersing step.

6. A method of making a strengthened article, comprising:
providing an article comprising a glass, glass-ceramic or ceramic composition with a plurality of ion-exchangeable alkali metal ions, a first primary surface and a second primary surface;
masking the first primary surface with a first masking film;
forming an anti-glare surface integral with the second primary surface after the step of masking the first primary surface;
removing the first masking film on the first primary surface after the step of forming an anti-glare surface;
masking the anti-glare surface with a second masking film;
etching the first primary surface with an etchant having a pH of less than 7 to form an etched first primary surface after the step of masking an anti-glare surface;
removing the second masking film on the anti-glare surface after the step of etching the first primary surface;
providing a first ion-exchange bath comprising a plurality of ion-exchanging alkali metal ions, each having a larger size than the size of the ion-exchangeable alkali metal ions; and
submersing the article in the first ion-exchange bath at a first ion-exchange temperature and duration to form a strengthened article, the submersing conducted after the step of removing the second masking film,
wherein the strengthened article comprises a compressive stress region extending from the etched first primary surface and the second primary surface to first and second selected depths, respectively.

7. The method according to claim 6, wherein the strengthened article comprises a change in warp (Δ warp) of 50 microns or less, as determined from warp measurements on the article before the submersing step and on the strengthened article after the submersing step.

8. The method according to claim 6, wherein the strengthened article comprises a change in warp (Δ warp) of 20 microns or less, as determined from warp measurements on the article before the submersing step and on the strengthened article after the submersing step.

9. The method according to claim 6, wherein the article comprises a glass composition selected from the group consisting of soda lime silicate, alkali aluminosilicate, borosilicate and phosphate glasses.

10. The method according to claim 6, wherein a change in haze (Δ haze) and change in gloss (Δ gloss) exhibited by the strengthened article is less than 10%, respectively, as determined from haze and gloss measurements on the article before the submersing step and on the strengthened article after the submersing step.

11.-15. (canceled)

16. A strengthened article made according to the method of claim 1.

17. A strengthened glass article, comprising:
a glass substrate comprising a first primary surface and a second primary surface, and a compressive stress region extending from the first and second primary surfaces to respective first and second selected depths,
wherein the second primary surface of the substrate comprises an integrally-formed anti-glare surface,
wherein the glass article comprises a change in warp (Δ warp) of 200 microns or less,
wherein the first primary surface comprises an etched first primary surface, and further wherein the change in warp is measured before and after formation of the compressive stress region, anti-glare surface and etched first primary surface in the glass substrate.

18. The glass article of claim 17, wherein the glass article comprises a change in warp (Δ warp) of 50 microns or less, and further wherein the change in warp is measured before and after formation of the compressive stress region, anti-glare surface and etched first primary surface in the glass substrate.

19. The glass article of claim 17, wherein the glass substrate comprises a glass composition selected from the group consisting of soda lime silicate, alkali aluminosilicate, borosilicate and phosphate glasses.

20. The glass article of claim 17, wherein the portions of the compressive stress region extending from the respective first and second primary surfaces are asymmetric.

21. The glass article of claim 17, wherein the portions of the compressive stress region extending from the first and second primary surfaces comprise different amounts of ion-exchanged ions that result from a chemical strengthening process.

22. The glass article of claim 17, wherein the glass article exhibits a change in haze of less than 1%, and further wherein the change in haze is measured before and after formation of the compressive stress region, anti-glare surface and etched first primary surface in the glass substrate.
